(19) United States
(12) Patent Application Publication
(10) Pub. No.: US 2009/0282694 A1
(43) Pub. Date: Nov. 19, 2009

(54) METHOD FOR TREATING FABRICS

(76) Inventors: Euan John Magennis, Tyne & Wear (GB); Graeme Duncan Cruickshank, Newcastle upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/465,078

(22) Filed: May 13, 2009

(30) Foreign Application Priority Data
May 13, 2008 (EP) 08156084.9

(51) Int. Cl. F26B 19/00; F26B 11/02

(52) U.S. Cl. 34/337; 34/499; 34/597

(57) ABSTRACT

A method of treating wet or dry fabrics in a dryer having a drum capable of tumbling, a liquid delivery system, an air inlet, an air current provider, an air outlet having a lint screen and optionally a venting system, the method comprising the steps of:

a) placing the fabrics into the drum;

b) delivering a treatment solution into the drum to deposit onto the fabrics either when the drum is stationary or when the drum is tumbling and either in the absence or presence of an air current; and

c) optionally tumbling and/or passing a current of air though the drum.

### TECHNICAL FIELD

The present invention is in the field of fabrics treatment. In particular, it relates to a method of treating fabrics in a dyer comprising the step of delivering a treatment solution onto the fabrics.

### BACKGROUND OF THE INVENTION

Fabrics are usually cleaned in a washing machine. The washing process involves full immersion of fabrics in an aqueous medium with cleaning agents, afterwards the fabrics are dried either on a laundry rack or in a tumble dryer. The process is usually completed by ironing the fabrics.

Items dried in a tumble dryer can lose some of the benefit agents acquired during the laundry, such as finishing agents, due to the air flow and relatively high temperature achieved during the drying. For example, perfume acquired during a laundry process can be evaporated during the drying leaving the clean and dried clothes devoid of perfume, same situation is found with other finishing agents such as softeners and fabric enhancers where scent benefit is also lost.

Sometimes fabrics, in particular clothes, are not dirty, they have been worn only once or a couple of times and the user would like to refresh them rather than subject them to the whole cleaning process, not only because of the time, energy and resources, but also because the cleaning process may contribute to wear and tear of the clothes.

The delivery of benefit agents to fabrics during the wash is difficult, firstly because the benefit agents can get diluted into the wash solution and secondly because they can get washed out with the wash or rinse water.

There is a need for refreshing fabrics and delivering finishing benefits onto them. There is also a need for simplifying or even obviating the ironing process. The goal of the present invention is to meet some or all of these unmet needs.

### SUMMARY OF THE INVENTION

According to a first aspect of the invention, there is provided a method of treating fabrics in a dryer. The method comprises the step of delivering a treatment solution onto the fabric.

A dryer traditionally has a drum capable of tumbling, an air current provider and optionally a venting system. Dryers suitable for use in the method of the invention further comprise a liquid delivery system. The method comprises the step of:

a) placing the fabrics into the drum;

b) delivering a treatment solution into the drum to deposit onto the fabric either when the drum is stationary or when the drum is tumbling and either in the absence or presence of an air current; and

c) optionally tumbling and/or passing a current of air though the drum.

The method of the invention is suitable for the treatment of wet fabrics. It permits the deposition of treatment agents in a more efficient way than a laundry process. In a laundry process the treatment agents are diluted in the wash liquor moreover if they are applied during the main wash they can be partially or totally removed in the rinse. In a dryer a treatment solution can be deposited directly onto the fabrics increasing the deposition efficiency with respect to that achieved in a laundry process.

The method of the invention is also suitable for the treatment of dry fabrics, providing re-freshening of the fabrics and/or finishing benefits, depending on the nature of the treatment solution or solutions delivered. The application of scent is one of the preferred benefits that can be applied to dry fabrics. Anti-wrinkle benefit is also one of the preferred finishing benefits that can be provided to the dry fabrics. Tumble dryers have been traditionally used only to dry wet fabrics. The method of the invention allows for a new application of the dryers, ie, to treat dry fabrics in order to provide freshening or finishing benefits.

The method of the invention is also suitable for treating a mixture of dry and wet fabrics. It has been found that when a mixture of wet and dry fabrics is treated, both, the dry and the wet fabrics benefit from each other's presence. The dry fabrics become slightly damp, contributing to wrinkle elimination and reducing the amount of electrostatic charge on the fabric.

In preferred embodiments the delivery of the treatment solution takes place when the drum is stationary, preferably in the absence of an air current. This avoids losses of the treatment solution within the air current.

In other embodiments, the delivery takes place when the drum is tumbling in the absence or presence of an air current, preferably in the absence of an air current. This contributes to a uniform and efficient distribution of the treatment solution onto the fabrics.

The treatment solution can be delivered at different points during the drying cycle. It can be delivered at the beginning of the drying cycle, intermittently at different points of the cycle or at the end of the cycle. The terms “at the beginning of the drying cycle” and “at the end of the drying cycle” include times ranging from five minutes before the cycle begins/ends to 5 minutes after the cycle begins/ends. The moment when the solution is delivered depends on the benefit provided by the solution. For example, it has been found advantageous to deliver perfume-comprising solutions at the end of the cycle, thereby reducing losses by evaporation during the drying. For re-freshening applications is advantageous to deliver the treatment solution at the beginning of the drying cycle. For some applications a single delivery is enough for other applications intermittent delivery (of the same or different treatment solution) is preferred. The placement of the nozzle and angle of the nozzle should be chosen so as to optimize the spray contact with the fabric in the dryer. A very effective way (in terms of uniform and efficient fabric coverage) of delivering the treatment solution is to select an angle such that the nozzle is not directly aimed at the dryer vent/lint screen or at the top of the drum. Furthermore, it is generally desirable that the nozzle be angled such that the spray from the nozzle is delivered through the void space/tunnel created by the tumbling of the fabrics around the perimeter of the dryer drum so as to contact the fabrics at the bottom of the rotating circle of fabrics. Also it may be effective that the nozzle be angled such that the spray intercepts the fabrics being tumbled in the dryer as the fabrics drop from their highest vertical point to their lowest vertical point during dryer drum rotation.

Dryers suitable for the method of the invention can optionally have a venting system. Preferred for use herein are dryers without a venting system, because they are more efficient in terms of treatment solution usage. In dryers with venting systems is preferred that the delivery of the treatment solution takes place with the venting system closed (to avoid losses).

The purpose of the present invention is not only to provide a method to deliver a treatment solution onto fabrics in a dryer but also to do it in a uniform and efficient way. The method of the present invention aims to avoid losses of the treatment solution. In addition the method of the invention should be safe and convenient.

In preferred embodiments the method of the invention provides:

a) a uniformity of distribution of the treatment solution onto the fabrics of at least about 35%, preferably at least 50%, more preferably at least about 60%, even more preferably at least about 70% and especially at least about 80%; preferably

b) a deposition of the treatment solution onto the fabrics of at least 60%, preferably at least about 75% and more preferably at least about 80%; and more preferably

c) a release of the treatment solution from the drum through the lint screen of less than about 10%, preferably less than about 5% and more preferably less than about 1 %;

Preferably, the treatment solution is delivered in the form of a spray preferably having:

a) droplets having a mean particle size of from about 100 microns to about 1400 microns, more preferably from about 200 microns to about 1300 microns, even more preferably from about 300 microns to about 1200 microns and especially from about 500 microns to about 1100 microns; and preferably

b) a flowrate of from about 0.5 to about 100 m/min, more preferably from about 1 to about 75 ml/minute, even more preferably from about 2 to about 50 ml/minute and especially from about 15 to about 25 ml/minute.

The liquid delivery system comprises an inlet, a reservoir, a delivery means and an outlet. The inlet is preferably in the form of an openable draw, preferably located on the front of the dryer. The reservoir is charged from the inlet. It should be suitable to hold a single dose (so each dose can be a different product, given the user maximum flexibility) and/or a plurality of doses (so the user does not need to fill it each time that the dryer is used, thereby simplifying the task). The reservoir could have different compartments for storage of different compositions that can be delivered simultaneously or separately (providing maximum flexibility and task simplification).

The delivery means preferably comprises a pump, more preferably an electric pump. Additionally the delivery means can comprise electrostatic means or ultrasonic means, especially piezo electric ultrasonic means, have been found to be especially suitable from a uniform and efficient delivery viewpoint.

The outlet is preferably closable so it can be closed when no delivery of liquid is taking place. This can help to avoid clogging of the outlet by lint generated during the drying process. It also contributes to maintain the treatment solution thermally isolated. In a preferred embodiment the outlet is in the form of a nozzle or a plurality of nozzles, preferably placed in a manner that will provide good uniformity of distribution and deposition of the treatment composition.

The method of the invention is suitable for delivering any treatment solution, preferred treatment solutions for delivering herein include a solution comprising a cleaning agent, a fabric finishing agent a skin care agent and mixtures thereof.

In another aspect of the invention there is provided a dryer for use in the method of the invention.

### DETAILED DESCRIPTION OF THE INVENTION

The present invention envisages a method of treating wet fabrics, dry fabrics or mixtures thereof in a dryer. The method comprises the step of delivering a treatment solution onto the fabrics in order to provide cleaning and finishing benefits.

A tumble dryer is a household appliance that traditionally is used to remove the moisture from a load of fabrics (clothing and other textiles), generally shortly after they are cleaned in a washing machine.

Most dryers consist of a rotating drum through which heated air is circulated to evaporate the moisture from the load. The drum is usually rotated relatively slowly in order to maintain space between the articles in the load. In most cases, the tumbler is motor driven, preferably belt-driven by an induction motor. Some dryers use a single motor to tumble the drum and to produce the air current. It has been found herein that dryers with two independent motors, one for the drum and another one to generate the air current give more flexibility of operation, allowing the delivery of the treatment solution when the drum is tumbling without air current, therby favoring level and evenness of deposition. This has also been found particularly suitable in the case of dry loads.

Dryers can be classified into two types: vented dryers and condensation dryers.

Vented dryers, also know as traditional dryers, continuously draw in the cool, dry, ambient air around them and heat it before passing it through the drum. Afterwards, the resulting hot, humid air is simply vented outside to make room for more dry air to continue the drying process. Just as in a traditional dryer, condensation dryers pass heated air through the load. However, instead of exhausting this air, the dryer uses a heat exchanger to cool the air and condense the water vapor into either a drain pipe or a collection tank. Afterwards, this air is recirculated through the loop again. The heat exchanger uses ambient air as its coolant, therefore the heat produced by the dryer will go into the immediate surroundings instead of the outside.

The dryers for use in the method of the invention have a liquid delivery system to deliver a treatment solution into the drum.

The method of the invention can be very flexible. It can be used for re-freshening and/or to apply finishing agents onto fabrics. If the method is used for re-freshening of fabrics, the treatment agent is preferably applied in the absence of an air current, more preferably when the drum is tumbling. The agent is preferably delivered at the beginning of a cycle.

The method of the invention can also be applied to deliver a treatment solution during the drying process of a full wet load. In preferred drying embodiments, the treatment solution is delivered before the drying starts and optionally, it is repeated a number of times during the process (with or without stopping the air flow during the delivery).

Preferably, the treatment solution is maintained and applied at room temperature (about 20° C.) for stability reasons. Some of the ingredients that can be part of the treatment solution can be temperature sensitive, such as perfumes, polymers, etc and they can be negatively affected by heat. Preferably the reservoir wherein the treatment solution is stored is thermally insulated.

The present invention aims to provide an even distribution of the treatment solution and high efficacy delivery, i.e, to minimize losses. In accordance with the present invention, it is desirable that the uniformity of distribution (herein referred to as Distribution Index) of the treatment composition on the fabric in the drum of the dryer be at least about 35%, preferably at least about 50%, more preferably at least about 60%, even more preferably at least about 70% and especially at least about 80%. It is desirable that the deposition of the treatment composition onto the fabric in the drum of the dryer be at least about 70%, preferably at least about 75% and more preferably at least about 80%. It is also desirable that less than about 10% of the treatment composition be released from the dryer drum through the lint screen, preferably less than about 5% of the treatment composition be released from the dryer drum through the lint screen and more preferably less than about 1% of the treatment composition be released from the dryer drum through the lint screen.

Method for Determining Uniformity of Distribution (Distribution Index) onto the Fabric

Image analysis may be used to evaluate uniformity of the treatment solution distribution per surface area of a test sample. A number of digital images are acquired per sample by imaging equipment and analyzed by computer software. The software detects a solution deposition area and provides a count of the number of pixels comprising the stained areas in the image. By comparison of the number of pixels detected for all images taken per sample, a standard deviation is calculated. A smaller standard deviation correlates to a more uniform solution distribution. In order to determine uniformity of distribution, a fabric sample is sprayed with red dye (i.e.; 0.0 wt 5% FD&C Red Dye #40 in distilled water). Image analysis is then conducted according to the following steps to evaluate the uniformity of distribution of solution on a sample.

1. Background Calibrate Image System and Acquire Digital Image of Sample Background Calibration

A well known technique for calibrating images using a flat neutral gray card, is applied to images before analysis to eliminate lighting variance across the field of view and minimize problems in image analysis due to spatial lighting variance.

Additionally, to insure colour consistency in the digital images taken at different times (e.g. images taken on different days), the images are also colour corrected using a standard colour chart (Greta” Macbeth 24 colour chart).

After calibrating the background, the fabric to be tested is placed in a light booth and fold such that the particular area to be imaged is at the centre of the light booth directly between the lamps and facing upwards towards the camera. A stencil in the size of the field of view of the camera (16 cm by 20.5 cm) is placed on the area to be imaged. A picture is taken in response to a command from the operator when the sample is correctly positioned. Six images are taken per front-side and back-side of the fabric for a total of 12 images per fabric.

The picture is digitized (i.e. converted to a binary representation) in a known manner. Finally, the digital image data is transferred to a computing device. Many other methods of acquiring the digital image are well known. For example, a sample to be analyzed may be submitted via the network, a file may be retrieved from a database, and/or a flatbed scanner may be used to digitize a photograph.

2. Electronically Analyze the Digital Image to Detect the Areas of Spray Deposition.

The image is electronically processed by image analysis software (Optimal v6.5 available from Media Cybernetics, Incorporated of Silver Spring, Md.) based on a reference intensity threshold. The region of interest selected is the entire screen image. The method for selecting the intensity threshold setting is as follows. The background and colour corrected images of the fabric (step 1 above) are converted to a single ‘gray’ level image representation that highlights the difference between the red dyed areas and ‘clean’ fabric areas. The green channel is used to create a single channel ‘gray’ level image for thresholding that accentuates the differences between the dyed and ‘clean’ areas of the fabric.

The software is calibrated to detect coloured areas in pixels of the digital images. To set the threshold for pixel detection, a “clean”, un-dyed white fabric is the standard reference and is imaged according to step (1). After converting to a single channel ‘gray’ level image representation, the threshold is set for which zero pixels are detected for all images for that “clean” sample, and such that increasing the threshold value any higher would make the software start detecting pixels on the “clean” sample. Pixels of a colour intensity value within the set threshold are detected and counted by the image analysis software.

3. Calculate Standard Deviation in Percent of Pixels Detected for all Images Per Sample

The percent of pixels detected per area is obtained by mathematical calculation using the number of pixels detected divided by the number of total pixels per image. Therefore for each fabric analyzed, there are twelve values of percent of pixels detected. For the twelve images per fabric, the standard deviation of percent of pixels detected is obtained by mathematical calculation, according to:

$$σ = \sqrt{\frac{{\sum }_{i} {( X - μ )}^{2}}{N - 1}}$$

### Where

σ=standard deviation

Xi=percent of pixels detected per image

μ=average value of the percent of pixels

N=number of values in the set of measurements.

To more conveniently compare the uniformity of solution deposition across fabrics, treatments, and the like, a Distribution Index is created by a mathematical equation using the standard deviation value. This distribution index is a scale from 0 to 100.

0<Distribution Index<or=100

$$Distribution Value = \frac{1}{( σ + 1 )} \times 100$$

Wherein a higher distribution index value correlates to a more uniformly distributed sample.

Method for Determining Deposition of the Treatment Composition on the Fabric and Deposition of the Treatment Composition on the Lint Screen

Firstly, the fabric to be tested is stripped, then the dryer is cleaned, the fabric is treated, sampled and analysed.

Fabric Stripping
1. 2.7 Kg of fabrics are weighed.
2. The washing machine is set on a 10 minutes agitation time and a high water level, approximately 21 gal fill.
3. 60 grams of a liquid laundry detergent such as Liquid TIDE is used.
4. The detergent is added to the washing machine water after it is approximately full. The laundry detergent bottle cap is rinsed out with water running into the machine so as to allow any remaining detergent in the cap to run into the washing machine.
5. Once the tub is filled to approximately ¾ full, the fabrics are added to the water in the washing machine.
6. The wash cycle is allowed to proceed automatically through completion of the final spin.
7. Steps #2-6 are repeated 3 more times, with the respective amounts of detergent added to the wash load as listed above.
8. After the 4th cycle is complete, the fabrics are removed from the washing machine and dried using the high heat cycle of a dryer.
9. The fabrics are then stored in plastic bags until treatment.

Dryer Cleaning Procedure

Before placing damp fabrics into the tumble dryer, the following Dryer Cleaning Procedure is performed before each treatment. A 5% bleach solution is sprayed inside the dryer on the front and back walls and the dryer drum. The lint screen is removed prior to spraying. The dryer is thoroughly wiped down with paper towels. Once dryer cleaning is complete, the lint trap of the dryer is replaced and covered with a new 14″ by 7″ piece of white cotton knit fabric secured on the edges by masking tape. A suitable white cotton knit fabric is CW120 available from Empirical Manufacturing Company of Cincinnati, Ohio. The damp fabrics are then placed into the dryer drum, and a drying cycle is completed. During the drying cycle, a treatment composition is delivered into the dryer drum. Following the drying treatment cycle, the fabrics are removed from the dryer drum as is the covering over the lint screen for sampling and analysis.

Fabric Treatment:

Fabric Load—Each treatment consists of using twelve 1 yard squares of stripped fabric swatches per load.

Treatment Process—The stripped fabric swatches are placed in the washing machine, set on the rinse cycle, wet and spun dry.

Fabric Sampling:

Lint screen—The fabric over the lint screen is sampled as follows:
1. The covering over the lint screen is sampled by removing it from the lint screen.
2. Six circular samples measuring 40 mm in diameter are cut from the portion of the lint screen cover which was not covered by the masking tape.
3. The six samples cut from the lint screen cover are labelled and analyzed according to the swatch analysis described below.

Fabric Load (from the Dryer)
1. Six of the twelve, one square yards of fabric are sampled from each cycle.
2. Each fabric swatch is unfolded and a ruler used to measure in six inches from the corner of the swatch.
3. A 40 mm circle is cut from this area.
4. Sample swatches are labelled and analyzed.

Swatch Analysis:

Inductively Coupled Plasma Optical Emission Spectrometry (ICP) is used to analyze the samples. In order to determine spray performance, Yttrium (Y) is spiked into the treatment composition solution as a tracer element. 200 ppm of Y are added into the treatment composition to be tested. The composition is delivered onto the fabric to be tested. Samples are cut from the fabric and the samples are digested via high pressure microwave to get into acidic solution.

The ICP is calibrated for quantitative Y determination. Y in solution is measured and the amount of Y on fabric is back calculated. Stoichiometric correction is applied to determine the amount of treatment solution on the fabrics. The distribution of Y is representative of the distribution of the treatment composition solution.

It is desirable that the treatment solution applied during the drying process be uniformly distributed onto the fabric in the dryer during the drying process. It is also desirable during the drying process that the treatment solution be deposited on the fabric that is in the dryer rather than deposited elsewhere such as through the dryer vent/lint screen.

While not wishing to be limited by theory it is believed that some factors which may possibly influence both uniformity of distribution and deposition of the treatment composition onto the fabric in the drum of the tumble dryer include flowrate of the treatment composition in the drum, the droplet size of the treatment solution, the position of the nozzle in the drum, the cone angle of the spray in the drum, the linear velocity of the treatment composition in the drum, etc.

Preferably, the treatment solution is delivered onto the fabric in the form of a spray having droplets with mean droplet size of from about 100 microns to about 1400 microns, more preferably form about 200 microns to about 1300 microns, even more preferably from about 300 microns to about 1200 microns and especially from about 500 microns to about 1100 microns. It is also preferred that droplet size distribution is such that less than 10% of the droplets have a size of less than 50 microns and less than 10% have a size greater than 1600 microns. By “size” is herein meant the diameter of the droplets. This droplet size range contributes to good distribution of the solution and avoids streaking and staining of the fabrics. A suitable instrument for measuring droplet size is the Malvern particle sizer manufactured by Malvern Instruments Ltd. of Framingham, Mass.

The flowrate of the spray in the drum is preferably from about 0.5 to about 100 ml/minute, more preferably from about 1 to about 75 ml/minute, even more preferably from about 2 to about 50 ml/minute and especially from about 15 to about 25 ml/minute. One suitable method for determining flow rate is found in ASME/ANSI MFC-9M-1988, entitled “Measurement of Liquid Flow in Closed Conduits by Weighing Method”.

Preferably, the linear velocity of the spray in the drum is from about 0.05 to about 2 m/second, more preferably from about 0.1 to about 1 m/second. The length of the spray in the drum of the tumble dryer is from about 20% to about 95% of the length of the drum as measured along the rotational axis of the drum. One suitable method for determining linear velocity is by utilizing Laser Doppler Anemometry such as described in “Laser Doppler and Phase Doppler Measurement Techniques” part of the “Experimental Fluid Mechanics” series, written by Albrecht, H. E., Damaschke, N., Borys, M., and Tropea, C., 2003, XIV, 738, page 382.

The cone angle of the spray refers to the angle the spray forms as it is sprayed into the drum of the tumble dryer. The cone angle of the spray is about 35° to about 150° or about 40° to about 110° or about 50° to about 90°.

Suitable treatment solutions for use in the method of the invention can have any physical properties. Especially preferred have been found to be Newtonian solutions having a viscosity of from about 0.1 to about 100 cp, preferably from about 1 to 50 cp (as measured at 25° C.) and a surface tension of from about 20 to about 35, preferably from about 25 to about 30 mN/M (as measured at 25° C.). The amount of solution dosed should be from about 10 to about 200 ml, preferably from about 20 to about 150 ml and more preferably from about 35 to about 100 ml.

The viscosity of the treatment composition is measured at approximately 24° C. using a Model DV-II Brookfield Viscometer with a LV I spindle. The Brookfield Model DV-II viscometer is available from Brookfield of Middleboro, Mass.

A suitable instrument for measuring static surface tension is a Kruss Tensiometer, Model K12 manufactured by Kruss of Matthews, N.C.

Means for Delivering the Treatment Solution

Any liquid delivery device can be used in the method of the invention. Preferably the treatment solution should be delivered in the form of spray. Suitable spraying systems include a pump, in which the fluid is transferred from a reservoir by a pump to a nozzle. The pump is generally an electrical pump operated by an electric motor. The fluid is sprayed through the atomizing nozzle. The properties of the spray can be controlled by modifying the nozzle geometry.

A suitable technology to deliver the treatment solution in the method of the invention is using ultrasonic means. The solution is passed through an ultrasonic horn which is vibrating, this creates pressure waves in the liquid and form fine droplets when the solution leaves the vibrating tip. The diameter of the outlet of the vibrating tip is larger than the diameter of the droplets generated. This helps to reduce problems of clogging and blockage that can occur in the outlet. Other advantages of ultrasonic spray are its capacity to handle materials with a wide range of viscosities and the low energy required. Ultrasonic means are described in JP4033698.

Electrostatic means are also suitable to deliver the treatment solution in the method of the invention. The treatment solution is electrically charged to drive deposition of the liquid onto the fabric article to be treated. It provides a very uniform and efficient deposition onto the treated fabric and reduces the losses through the lint screen. Electrostatic means are described in US20040025368. “Electrically charged liquid” as used herein means any liquid, typically aqueous liquid, that has an applied potential in the range of from about 0.2 to about 50 kV and/or from about 0.5 to about 30 kV and/or from about 0.5 to about 25 kV. The liquid may have a negative charge potential, a positive charge potential, or a charge potential which oscillates therebetween. The electrically charged liquid may contain a moiety capable of acquiring an electric charge and optionally, capable of retaining an electric charge for a time period sufficient for the electrically charged liquid to contact a fabric article being treated by the electrically charged liquid.

The source of electrically charged liquid may comprise an electrical charging component, typically an electrical field, that electrically charges the liquid and/or a moiety present in the liquid that is capable of acquiring an electric charge and optionally, capable of retaining an electric charge for a time period sufficient for the electrically charged liquid to contact a fabric article being treated.

Suitable for use herein is a spray nozzle unit which includes a treatment solution jetting nozzle and an air jetting nozzle. Air pressurized by an air pump is jetted out from the jetting nozzle toward the fabrics in a direction substantially perpendicular to a jetting out direction of the treating solution jetting nozzle. The treatment solution spray nozzle communicates with a treatment solution dispenser from where the treatment solution is dispensed.

The air pump has a driving source for varying the jetting pressure of air, and a controller to control the air pump. If a DC motor is used as the driving source of the air pump, it is possible to vary the jetting out pressure of air by controlling a current applied to the motor. If the driving source of the air pump is an AC motor, on the other hand, the jetting out pressure of air can be varied by controlling a driving frequency of the driving source of the air pump. Moreover, the treatment solution jetting nozzle, the air pump, the air jetting nozzle and the controller jointly form a treatment solution spray unit.

When the air pump is operated, air is ejected out from the air jetting nozzle at a high speed, so that the air pressure along the ejected air direction as well as around the path of the treatment solution jetting nozzle located at a vicinity of the air jetting nozzle in a vertical direction thereto becomes a negative pressure due to an ejector effect. As a consequence, the treatment solution is atomized into a fine mist-like solution.

As used herein, “treatment agent” means a material or combination of materials that can deliver benefits to a fabric article. Examples of such benefits include but are not limited to; softening, crispness, water and/or stain repellency, refreshing, antistatic, anti-shrinkage, anti-microbial, durable press, wrinkle resistance, odor resistance, abrasion resistance, anti-felting, anti-pilling, dimensional stability, appearance enhancement such as colour and whiteness enhancement, anti-soil redeposition, skin care, anti-insect, fragrance, enhanced absorbency, and mixtures thereof. As used herein, “treatment solution” means a composition that comprises one or more treatment agents.

The treatment composition may be delivered through a nozzle (or a plurality of nozzles) into the drum of a dryer. The nozzle typically will have a diameter of about 200 to about 600 microns or about 250 to about 400 microns. A non-limiting example of a nozzle suitable for this purpose is a pressure swirl atomizing nozzle. Non-limiting examples of suitable nozzles include the Cosmos 13 NBU nozzle manufactured by Precision Valve Corporation of Marietta, Ga., the WX12 and WD32 nozzles manufactured by Saint-Gobain Calmar USA, Inc. of City of Industry, Calif., and Seaquist Model No. DU-3813 manufactured by Seaquist Dispensing of Cary, Ill. The nozzle may be in association with a spraying device. The nozzle may be permanently attached or releaseably attached to a spraying device. One non-limiting example of a releaseably attached nozzle is a nozzle which is threaded such that it can easily be removed from or placed in a spraying device. The nozzle may be disposable.

It is desirable that the fabrics in the dryer do not come into direct contact with the nozzle while the nozzle is operating as this may inhibit flow from the nozzle. Hence, it may be desirable for the nozzle to include a deflector which deflects the fabric away from the nozzle. The deflector may surround all or a portion of the nozzle (for example the top portion of the nozzle). The degree of extension of the deflector into the dryer is selected so as to insure that the deflector does not intercept the cone angle of the spray under normal use conditions. The deflector may be made from any suitable material, non-limiting examples of which include plastic, metal, Plexiglas, and the like. The deflector may be of any shape provided that the shape selected does not negatively impact fabric integrity during tumble drying process (i.e.; no sharp edges/corners or rough surfaces).

The placement of the nozzle and angle of the nozzle may be varied so as to optimize the spray contact with the fabric in the dryer. The angle is typically selected such that the nozzle is not directly aimed at the dryer vent/lint screen or at the top of the drum. Furthermore, it is generally desirable that the nozzle be angled such that the spray from the nozzle is delivered through the void space/tunnel created by the tumbling of the fabrics around the perimeter of the dryer drum so as to contact the fabrics at the bottom of the rotating circle of fabrics. Also it may be desirable that the nozzle be angled such that the spray intercepts the fabrics being tumbled in the dryer as the fabrics drop from their highest vertical point to their lowest vertical point during dryer drum rotation.

It may be desirable in some instances to utilize more than one nozzle. Each nozzle could be designed to spray concurrently or at different times, flow rate, velocity, etc. than the other nozzle(s).

Non-limiting examples of suitable liquid delivery systems which may be used with the present invention are disclosed in the following applications: U.S. Patent Application Publication No. 2004/0259750, published on Dec. 23, 2004 and entitled “Processes and Apparatuses for Applying a Benefit Composition to One or More Fabric Articles During a Fabric Enhancement Operation”; WO 2004/12007, published on Nov. 4, 2004 and entitled “Volatile Material Delivery Method”; U.S. Patent Application Publication No. 2004/0123490, published Jul. 1, 2004 and entitled “Fabric Article Treating Method and Device Comprising a Heating Means”; U.S. Patent Application Publication No. 2004/0123489, published on Jul. 1, 2004 and entitled “Thermal Protection of Fabric Article Treating Device”; U.S. Patent Application Publication No. 2004/0134090, published on Jul. 15, 2004 and entitled “Fabric Article Treating Device Comprising More Than One Housing”; U.S. Application Publication No. 2004/0025368, published on Jul. 29, 2004 and entitled “Fabric Article Treating Apparatus with Safety Device and Controller”; and U.S. Application Publication No. 2004/0025368, published on Feb. 12, 2004 and entitled “Fabric Article Treating Method and Apparatus”.

Virtually any type of pump and electric motor combination can be utilized in some form or another to create a useful device that falls within the teachings of the present invention, or a stand-alone pump can be used (i.e., without an associated electric motor).

It should be noted that some types of pumps do not require separate input and output lines or tubes to be connected thereto, such as peristaltic pumps, in which the pump acts upon a continuous tube that extends through an inlet opening and continues through a discharge opening of the pump. This arrangement is particularly beneficial for use with electrostatically charged fluids that are being pumped toward the discharge nozzle, because the tubing can electrically insulate the pump from the charged benefit composition. It should also be noted that an alternative pumping device could be used, if desired, such as a spring-actuated pumping mechanism. A non-limiting example of a suitable peristaltic pump is the Model IO/30 peristaltic pump, which may be obtained from Thomas Industries of Louisville, Ky.

If desired, the dryer can be enhanced by use of certain sensors, examples of which include but are not limited to a door (or lid) sensor, a motion sensor, a humidity sensor and/or a temperature sensor.

In a preferred embodiment, the pump and the motor comprise a single assembly, namely, a piezoelectric pump, one of which is commercially available from Par Technologies, LLC, under the product designation LPD-30S. Other suitable pumps which can be used in this or other embodiments include but are not limited to gear pumps and diaphragm pumps. One non-limiting example of a suitable diaphragm pump is model No. NFSRPDC-S with a DC motor available from KNF Neuberger, Inc. of Trenton, N.J.

The types of control signals used to control the electric motor can vary according to the design requirements of the apparatus, and such signals will travel to the motor via an electrical conductor. In the illustrated embodiment, the electrical signal travelling along conductor comprises a pulse-width modulated (PWM) signal controlled by the microcontroller. Of course, such a pulse-width modulated signal can also be generated by any appropriate controller or processor, or appropriate discrete logic.

Treatment agents suitable for the treatment solutions for use herein can provide one or more fabric benefits including, but not limited to, softness, anti-soil re-deposition, stain or water repellency, colour or whiteness enhancement, fragrance, enhanced absorbency, anti-static, anti-bacterial, wrinkle control, shape/form retention, and/or fabric abrasion resistance. Typically, a treatment agent is present, based on total composition weight, at one of the following levels, at least about 0.5 wt %, at least about 2 wt %, from about 4 wt % to about 90 wt %, from about 4 wt % to about 50 wt %, or from about 4 wt % to about 10 wt %. Suitable treatment agents include but are not limited to those disclosed in WO 2004/12007, published on Nov. 4, 2004 and entitled “Volatile Material Delivery Method”; WO 00/24856, published on May 4, 2000 and entitled “Fabric Care Composition and Method”; U.S. Patent Application Publication No. 2005/0022311 published on Feb. 3, 2005 and entitled “Fabric Article Treating System and Method”; U.S. Patent Application Publication No. 2005/0076534, published on Apr. 14, 2005 and entitled “Fabric Article Treating Device and System with Static Control”.

A preferred treatment agent for use herein is a perfume. The treatment solution may comprise at least about 0.005 wt. %, preferably from about 0.005 wt. % to about 10 wt% more preferably from about 0.1 wt. % to about 2 wt. % of a material such as a perfume that comprises at least about 30 wt.%, preferably from about 35 wt % to about 100 wt. %, more preferably from about 40 wt % to about 100 wt.% and even more preferably from about 40 wt % to about 70 wt. % of a perfume material having a boiling point of less than or equal to about 250° C. at 1 atmosphere; a fabric agent material; an optional carrier and the balance being one or more adjunct ingredients such as disclosed in WO 2004/12007.

The treatment solution may also include from about 0.5 to about 20% of fabric softeners or fabric modifiers non-limiting examples of which include diester quaternary ammonium compounds, polyquatemary ammonium compounds, triethanolamene esterified with carboxylic acid and quatemized materials, amino esterquats, cationic diesters, betain esters, betaines, silicone or silicone emulsions comprising amino silicones, cationic silicones, quat/silicone mixtures, functionalized polydimethyl siloxanes (“PDMS”), amine oxides, silicone co-polyols, cationic starches, sucrose fatty esters, polyethylene emulsions, and mixtures thereof.

The treatment solution used in conjunction with the present invention may also include from about 0.1 to about 1.2% of antistatic agents non-limiting examples of which include polyanilines, polypyrroles, polyacetylene, polyphenylene, polythiophenes, ethoxylated polyethyleneimines, and various commercial materials such as STATEXAN WP, STATEXAN HA, or STATEXAN PES (available from LanXess—a subsidiary of Bayer located in Leverkusen, Germany), ETHOFAT (available from Akso Nobel of Arnhem, Netherlands), and mixtures thereof.

The treatment solution may also include from about 0.005 to about 1.5% of malodour control agents non-limiting examples of which include substituted or unsubstituted cyclodextrins, porous inorganic materials, starch, olfactory odour blockers and mixtures thereof.

The treatment solution may also include from about 0.05 to about 0.5% of preservatives non-limiting examples of which include didecyl dimethyl ammonium chloride which is available under the tradeneme UNIQUAT (from Lonza of Basel Switzerland), 1,2-benzisothiozolin-3-one, which is available under the tradename PROPEL (from Arch Chemicals of Norwalk, Connecticut), dimethylol-5,5-dimethylhydantoin which is available under the tradeneme DANTOGUARD (from Lonza of Basel Switzerland), 5- Chloro-2- methyl-4- isothiazolin-3-one/2-methyl-4-isothiazolin-3-one, which is available under the tradename KATHON (from Rohm and Haas of Philadelphia, Pa.), and mixtures thereof.

The treatment solution may also include from about 0.05 to about 5% of ethoxylated surfactants and/or emulsifiers. These may include, but are not limited to carboxylated alcohol ethoxylates, ethoxylated quaternary ammonium surfactants, ethoxylated alkyl amines, alkyl phenol ethoxylates, alkyl ethoxylates, alkyl sulfates, alkyl ethoxy sulfates, polyethylene glycol/polypropylene glycol block copolymers, fatty alcohol and fatty acid ethoxylates, long chain tertiary amine oxides, alkyl polysaccharides, polyethylene glycol (“PEG”) glyceryl fatty esters and mixtures thereof.

The treatment solution can be formulated into any suitable form and prepared by any process chosen by the formulator, non-limiting examples of which are described in U.S. Pat. No. 6,653,275.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating wet or dry fabrics in a dryer having a drum capable of tumbling, a liquid delivery system, an air inlet, an air current provider, an air outlet having a lint screen and optionally a venting system, the method comprising the steps of:
a) placing the fabrics into the drum;
b) delivering a treatment solution into the drum to deposit onto the fabrics either when the drum is stationary or when the drum is tumbling and either in the absence or presence of an air current; and
c) optionally tumbling and/or passing a current of air though the drum.

2. A method according to claim 1 wherein the delivery of the treatment solution takes place when the drum is stationary.

3. A method according to claim 1 wherein the delivery of the treatment solution takes place when the drum is tumbling either in the absence or in the presence of an air current.

4. A method according to claim 1 capable of providing:
a) a uniformity of distribution of the treatment solution onto the fabrics of at least about 35%;
b) a deposition of the treatment solution onto the fabrics of at least 60%; and
c) a release of the treatment solution from the drum through the lint screen of less than about 10%;

5. A method according to claim 1 wherein the treatment solution is delivered in the form of a spray and wherein the spray has:
a) droplets having a mean particle size of from about 100 microns to about 1400 microns; and preferably
b) a flowrate of from about 0.5 to about 100 m/min

6. A method according to claim 1 wherein the liquid delivery system comprises an inlet, a reservoir, a delivery means and an outlet and wherein the delivery means comprises a pump, preferably an electrical pump, and optionally electrostatic means, ultrasonic means or a mixture thereof and wherein the outlet of the liquid delivery system is in the form of a nozzle or a plurality of nozzles, preferably located on the door of the dryer.

7. A method according to claim 1 wherein the treatment solution is delivered into the drum in the direction of the axis of rotation of the drum.

8. A method according to claim 1 wherein the treatment solution comprises a treatment agent selected from cleaning agents, fabric finishing agents, skin care agents and mixtures thereof.

9. A dryer for use in the method of claim 1.
